(19) United States
(12) Patent Application Publication
(10) Pub. No.: US 2019/0001652 A1
(43) Pub. Date: Jan. 3, 2019

(54) METHOD FOR PRODUCING METAL-CARBON FIBER COMPOSITE MATERIAL

(71) Applicant: SHOWA DENKO K.K., Tokyo (JP)

(72) Inventor: Tatsuhiro MIZO, Tochigi (JP)

(73) Assignee: SHOWA DENKO K.K., Tokyo (JP)

(21) Appl. No.: 16/065,680

(22) PCT Filed: Aug. 25, 2016
(86) PCT No.: PCT/JP2016/074733

§ 371 Date: Jun. 22, 2018

(30) Foreign Application Priority Data
Dec. 24, 2015 (JP) 2015-251416

(51) Int. Cl. B32B 37/15; B32B 15/08; B32B 15/20; B32B 37/10; B32B 38/00; B05D 1/28

(52) U.S. Cl. CPC B32B 37/15; B32B 15/08; B32B 15/20; B32B 37/10; B32B 2255/26; B05D 1/28; B32B 2307/304; B32B 2262/106; B32B 2255/06; B32B 38/0036

(57) ABSTRACT

A method for producing a metal-carbon fiber composite material includes the steps of: obtaining a coated foil (12) in which a carbon fiber layer (11) is formed on a surface (10a) of a metal foil (10) by applying a coating liquid (5) containing carbon fibers (1), etc., on the surface (10a) of the metal foil (10) with a gravure coating device (20); forming a laminate in which a plurality of coated foils (12) is laminated; and integrally joining the coated foils (12) by heating while pressurizing the laminate in a lamination direction of the coated foils (12). The shape of a cell (22) of a circumferential surface (21a) of a gravure roll (21) of the gravure coating device (20) is a cup shape and a diameter of a circle inscribed in a mouth shape of the cell (22) is set to 1.2 times or more the average fiber length.

### FIELD OF THE INVENTION

The present invention relates to a method for producing a metal-carbon fiber composite material and a method for producing an insulating substrate.

In this specification and appended claims, the term “aluminum” is used to mean both pure aluminum and an aluminum alloy unless otherwise specified, and in the same manner, the term “copper” is used to mean both pure copper and a copper alloy unless otherwise specified.

A vertical direction of an insulating substrate according to the present invention is not limited. However, in this specification and appended claims, for the purpose of facilitating the understanding of the configuration of the insulating substrate, the mounting surface side of the insulating substrate on which a heat generating element is mounted is referred to as the upper side of the insulating substrate, and the opposite side thereof is referred to as the lower side of the insulating substrate.

### BACKGROUND ART

As a material improved in heat dissipation of metal such as aluminum and controlled in linear expansion coefficient, an aluminum-carbon material composite material is being studied.

As a method for producing this composite material, a method in which carbon fibers as a carbon material are put in molten aluminum and stirred and mixed (molten metal stirring method), a method of pushing molten aluminum into a carbon molded body having cavities (molten metal forging method), a method in which aluminum powder and carbon powder are mixed and heated under pressure (powder metallurgy method), and a method in which aluminum powder and carbon powder are mixed and extruded (powder extrusion method) are known.

However, with these methods, since molten aluminum or aluminum powder is used, the production work was complicated and the producing equipment was large.

Japanese Unexamined Patent Application Publication No. 59-76840 (Patent Document 1) discloses a method of producing a reinforced metal material by producing a precursor molded product (prepreg) by bonding or adhering an inorganic whisker to a metal surface of a thin metal sheet with an organic binder, and then heating and pressurizing a plurality of precursor molded products in a laminated manner.

Further, Japanese Patent No. 5150905 (Patent Document 2) discloses a method for producing a metal-based carbon fiber composite material as a metal-carbon fiber composite material. In the method, carbon fibers are mixed with an organic binder and a solvent to prepare a coating mixture. Subsequently, the coating mixture is adhered on a sheet-like or foil-like metal support to form a preform foil (coated foil). Thereafter, a plurality of preformed foils is stacked to form a laminate. Then, the laminate is heated and pressurized to integrate the preform foils with each other.

Other than the above, as other documents disclosing a method for producing a metal-carbon fiber composite material, there are Japanese Patent No. 5145591 (Patent Document 3) and Japanese Unexamined Patent Application Publication No. 2015-25158 (Patent Document 4).

In the production method disclosed in Patent Documents 2 to 4 described above, a metal-carbon fiber composite material obtained by integrally joining a plurality of metal layers and carbon fiber layers in an alternately laminated state is obtained.

### PRIOR ART DOCUMENT

### Patent Document

Patent Document 1: Japanese Unexamined Patent Application Publication No. 59-76840
Patent Document 2: Japanese Patent No. 5150905
Patent Document 3: Japanese Patent No. 5145591
Patent Document 4: Japanese Unexamined Patent Application Publication No. 2015-25158

### SUMMARY OF THE INVENTION

### Problems to be Solved by the Invention

Thus, in the method for producing a composite material disclosed in the aforementioned Patent Document 1, when the inorganic whisker layer bonded or adhered to a metal surface of a metal thin plate is too thick, the metal of the metal thin plate cannot penetrate sufficiently into the inorganic whisker layer, cavities are formed in the inorganic whisker layer, and the metal thin plates disposed on both sides of the inorganic whisker layer are not strongly joined to each other. For these reasons, the strength of the composite material was low.

The composite materials disclosed in Patent Documents 2 to 4 had the following drawbacks.

It should be noted that, in this specification, in a composite material, a planar perpendicular to a lamination direction of a metal layer and a carbon fiber layer is referred to as a “planar of a composite material”, and a planar direction perpendicular to the lamination direction of the metal layer and the carbon fiber layer is referred to as a “planar direction of a composite material”.

In a composite material, in cases where fiber directions of carbon fibers in a carbon fiber layer are aligned in one direction within a planar of the composite material, that is, in cases where the carbon fibers are oriented in one direction, physical properties of the composite material, such as a linear expansion coefficient and a thermal conductivity, greatly differ in the fiber direction (that is, the orientation direction of the carbon fiber) of the carbon fiber in the planar of the composite material and in a direction perpendicular thereto. Therefore, there was a disadvantage that the composite material was easily distorted when the composite material was heated.

Under the circumstance, it is conceivable to form a laminate by laminating a plurality of preform foils such that fiber directions of carbon fibers become alternately perpendicular.

However, in this method, the preform foils must be laminated while considering the fiber directions of the carbon fibers, so the lamination work is troublesome. Moreover, it was difficult to make the physical properties (e.g., linear expansion coefficient) in the oblique direction (e.g., 45 degrees direction) with respect to the fiber direction of the carbon fiber in the planar of the composite material equal to the physical properties of the carbon fiber in the fiber direction and a direction perpendicular thereto.

The present invention was made in view of the aforementioned technical background, and its object is to provide a method for producing a metal-carbon fiber composite material which can equalize physical properties of the composite material in a planar direction, and a method for producing an insulating substrate.

The other purposes and advantages of the present invention will be made apparent from the following preferred embodiments.

### Means for Solving the Problems

The present invention provides the following means.

[1] A method for producing a metal-carbon fiber composite material, the method comprising the steps of:

obtaining a coated foil in which a carbon fiber layer is formed on a surface of a metal foil by applying a coating liquid containing carbon fibers, a binder, and a solvent for the binder in a mixed state to the surface of the metal foil with a gravure coating device provided with a gravure roll in which a number of cells are formed on a circumferential surface thereof;

forming a laminate in a state in which a plurality of coated foils are laminated; and

integrally joining the coated foils by heating the laminate to remove the binder from the laminate and heating the laminate while pressurizing the laminate in a lamination direction of the coated foils,

wherein a shape of the cell of the gravure roll is a cup shape and a diameter of a circle inscribed in a mouth shape of the cell is set to 1.2 times or more an average fiber length of the carbon fibers.

[2] The method for producing a metal-carbon fiber composite material as recited in the aforementioned Item 1, wherein the step of obtaining the coated foil includes a step of removing the solvent from the carbon fiber layer formed on the surface of the metal foil.

[3] The method for producing a metal-carbon fiber composite material as recited in the aforementioned Item 1, wherein the step of obtaining the coated foil includes a step of removing the solvent from the carbon fiber layer formed on the surface of the metal foil without subjecting the surface of the carbon fiber layer to slide leveling processing.

[4] The method for producing a metal-carbon fiber composite material as recited in any one of the aforementioned Items 1 to 3, wherein in the step of integrally joining the coated foils, the binder is removed from the laminate in the middle of heating the laminate so that a temperature of the laminate rises to a temperature at which the coated foils are integrally joined.

[5] The method for producing a metal-carbon fiber composite material as recited in any one of the aforementioned Items 1 to 4, wherein the shape of the cell is at least one shape selected from the group consisting of a lattice shape, a pyramid shape, a hexagonal shape, and a circular shape.

[6] The method for producing a metal-carbon fiber composite material as recited in any one of the aforementioned Items 1 to 5, wherein the metal foil is at least one of an aluminum foil and a copper foil.

[7] A method for producing an insulating substrate having a plurality of insulating substrate constituent layers to be integrated in a laminated state, wherein

at least one constituent layer of the plurality of constituent layers is made of a metal-carbon fiber composite material, and

the composite material is produced by a method for producing of the metal-carbon fiber composite material as recited in any one of the aforementioned Items 1 to 6.

### Effects of the Invention

The present invention exerts the following effects.

In the aforementioned Item [1], by adopting the steps of applying a coating liquid on a surface of a metal foil, forming a laminate in a state in which a plurality of coated foils is laminated, and integrally joining the coated foils by pressurizing and heating the laminate, a metal-carbon fiber composite material can be inexpensively mass-produced.

Furthermore, by removing the binder from the laminate, the thermal conductivity of the obtained composite material can be assuredly increased.

Furthermore, by configuring such that the coating apparatus for applying a coating liquid on the surface of the metal foil is the gravure coating device, the cell shape of the gravure roll of the gravure coating device is a cup shape, and the diameter of the circle inscribed in the mouth shape of the cell is set to 1.2 times or more the average fiber length of the carbon fiber, a carbon fiber layer can be formed on the surface of the metal foil so that the fiber directions of the carbon fibers in the surface of the metal foil become random. For this reason, the physical properties of the composite material in the planar direction can be equalized. Moreover, it is unnecessary to consider the fiber directions of the carbon fibers when forming the laminate, so that the physical properties of the composite material in the planar direction can be easily equalized.

In the aforementioned Item [2], by removing the solvent from the carbon fiber layer, it is possible to satisfactorily integrally join the coated foils in the step of integrally joining the coated foils.

In the aforementioned Item [3], by not subjecting the surface of the carbon fiber layer to slide leveling processing, the fiber directions of the carbon fibers in the carbon fiber layer can be maintained in a random state. As a result, uniformity of the physical properties of the composite material in the planar direction can be attained assuredly.

In the aforementioned Item [4], the production of the composite material can be easily performed by removing the binder from the laminate in the middle of heating the laminate so that the temperature of the laminate rises to the temperature at which the coated foils are integrally joined.

In the aforementioned Item [5], the shape of the cell is at least one shape selected from the group consisting of a lattice shape, a pyramid shape, a hexagonal shape, and a circular shape. For this reason, the carbon fiber layer can be formed on the surface of the metal foil so that the fiber directions of the carbon fibers in the surface of the metal foil become random assuredly. As a result, uniformity of the physical properties of the composite material in the planar direction can be attained assuredly.

In the aforementioned Item [6], since the metal foil is at least one of an aluminum foil and a copper foil, a composite material having high thermal conductivity can be assuredly obtained.

In the aforementioned Item [7], an insulating substrate having high reliability against temperature changes, such as, e.g., a cold heat cycle, can be produced.

### BRIEF DESCRIPTION OF THE DRAWINGS

FIG. 1 is a flowchart showing a method for producing a metal-carbon fiber composite material according to an embodiment of the present invention.

FIG. 2 is a schematic diagram illustrating steps of obtaining a coated foil.

FIG. 3A is a plan view illustrating an arrangement state of lattice shape cells on a circumferential surface of a gravure roll.

FIG. 3B is a perspective view showing the shape of the lattice shape cell of FIG. 3A.

FIG. 4A is a plan view illustrating an arrangement state of pyramid shape cells on a circumferential surface of the gravure roll.

FIG. 4B is a perspective view showing the shape of the pyramid shape cell of FIG. 4A.

FIG. 5A is a plan view illustrating an arrangement state of hexagonal shape cells in a circumferential surface of a gravure roll.

FIG. 5B is a perspective view showing the shape of the hexagonal shape cell of FIG. 5A.

FIG. 6A is a plan view illustrating an arrangement state of circular shape cells on a circumferential surface of a gravure roll.

FIG. 6B is a perspective view showing the shape of the circular shape cell of FIG. 6A.

FIG. 7A is a side view of a cell in a case where the bottom surface of the cell has a flat shape.

FIG. 7B is a side view of the cell in a case where the bottom surface of the cell has a concave curved shape.

FIG. 7C is a side view of the cell in a case where the bottom surface of the cell has a concave conical shape.

FIG. 8 is a perspective view of a cell in a case where communication ports are provided on the inner peripheral side surface of the cell.

FIG. 9 is a schematic view when a strip member of the coated foil is cut.

FIG. 10 is a schematic side view of a laminate formed by laminating a plurality of coated foils.

FIG. 11 is a schematic view for explaining a step of integrally sintering coated foils.

FIG. 12 is a diagram (graph) showing an example of a temperature curve at the time of heating a laminate in the step of integrally sintering coated foils.

FIG. 13 is a schematic side view of a composite material of this embodiment obtained by integrally sintering coated foils.

FIG. 14 is a perspective view of a composite material showing various directions defined by a composite material of this embodiment.

FIG. 15 is a side view of an insulating substrate.

### EMBODIMENT FOR CARRYING OUT THE INVENTION

Hereinafter, an embodiment of the present invention will be described with reference to the attached figures.

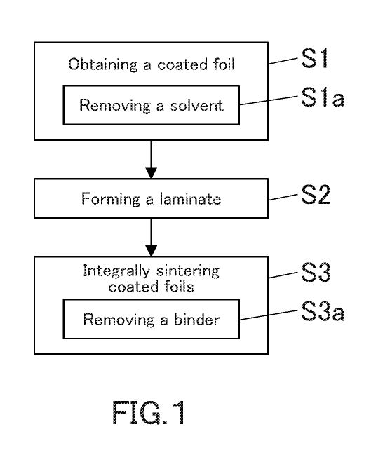

As shown in FIG. 1, a method for producing a metal-carbon fiber composite material (composite) according to an embodiment of the present invention includes Step S1 of obtaining a coated foil, Step S2 of forming a laminate, and Step S3 of integrally sintering the coated foils. These steps are performed in this order.

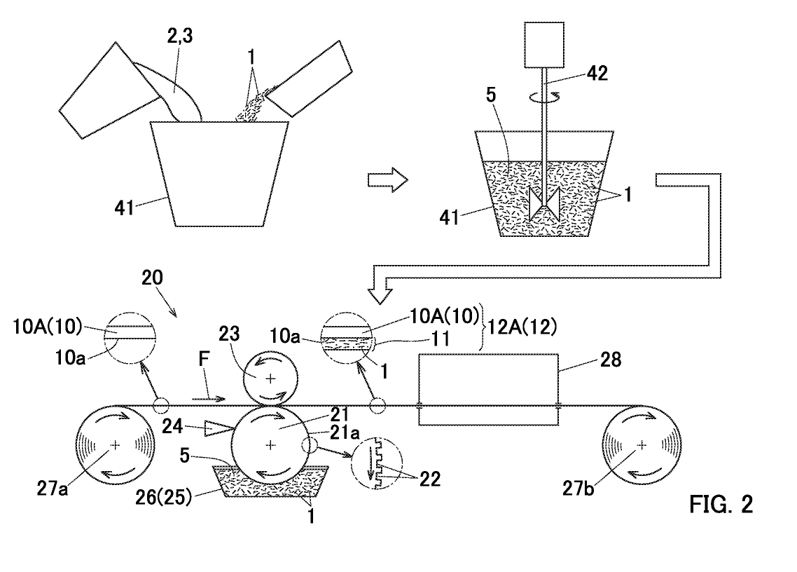

Step S1 of obtaining a coated foil is a step of obtaining a belt-like strip member 12A of the coated foil 12 (that is, a belt-like long coated foil 12) as described in detail in FIG. 2. In other words, this step S1 is a step of obtaining a strip member 12A of the coated foil 12 in which the carbon fiber layer 11 made of a coating liquid 5 is formed on the surface 10a of the strip member 10A of the metal foil 10 by applying the coating liquid 5 on the surface 10a of the strip member 10A of the metal foil 10. The coating liquid 5 is a mixture containing a carbon fiber 1, a binder 2, and a solvent 3 for the binder 2 in a mixed state.

Furthermore, Step S1 of obtaining the coated foil 12 includes a step S1a of removing the solvent 3 from the carbon fiber layer 11 formed on the surface 10a of the strip member 10A of the metal foil 10 (see FIG. 1).

As shown in FIG. 10, Step S2 of forming a laminate 15 is a step of forming a laminate 15 in a state in which a plurality of coated foils 12 are laminated.

As shown in FIG. 11, Step S3 of integrally sintering the coated foils 12 is a step of integrally sintering the coated foils 12 by heating while pressurizing the laminate 15 in the lamination direction of the coated foils 12 (that is, the thickness direction of the laminate 15). This Step S3 includes a step S3a of removing the binder 2 from the laminate 15 by heating the laminate 15 (see FIG. 1).

Step S3 of integrally sintering the coated foils 12 corresponds to a preferable example of the step of integrally joining the coated foils 12 recited in claims.

The metal-carbon fiber composite material 17 according to this embodiment means a composite material containing metal used as a matrix and carbon fibers 1 as a material to be composited with the metal (matrix). That is, this composite material 17 can be regarded as a metal matrix composite material containing carbon fibers 1.

As shown in FIG. 13, the composite material 17 obtained in this embodiment is a composite material in which a metal layer made of a metal foil 10 and a carbon fiber layer 11 mainly composed of carbon fibers 1 are integrally sintered in an alternately laminated manner. A part of metal of the metal foil 10 is permeated into the carbon fiber layer 11. In this composite material 17, the metal corresponds to the matrix, and the carbon fiber 1 corresponds to the material to be composited with the metal (matrix).

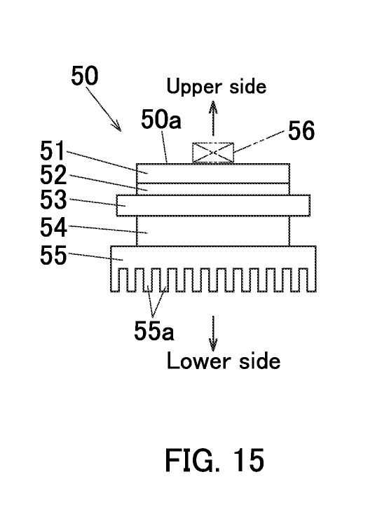

This composite material 17 can be suitably used as a material of at least one constituent layer among the plurality of insulating substrate constituent layers 51 to 55 constituting the insulating substrate 50 shown in FIG. 15.

The insulating substrate 50 is used as an electronic module substrate such as a power module substrate. The insulating substrate 50 is composed of, as a plurality of constituent layers, a wiring layer 51, a first stress buffer layer 52, a ceramic layer (insulating layer) 53, a second stress buffer layer 54, and a metal cooling layer 55. These constituent layers 51 to 55 are integrally joined by a predetermined joining means such as brazing in a state in which the wiring layer 51, the first stress buffer layer 52, the ceramic layer 53, the second stress buffer layer 54, and the cooling layer 55 are laminated in the order from the top to the bottom.

The mounting surface 50a of the insulating substrate 50 is configured to mount a heat generating element 56 (indicated by a two-dot chain line), such as, e.g., an electronic element, in a state of being joined by soldering or the like. The mounting surface 50a is constituted by the upper surface of the wiring layer 51.

The cooling layer 55 is a layer for cooling the heat generating element 56 and includes, for example, a plurality of heat dissipating fins 55a which are cooling members (including heat radiation members). Generally, the cooling layer 55 is made of aluminum or copper.

In the composite material 17 of this embodiment, the linear expansion coefficient in the planar direction may be set to an intermediate value between the linear expansion coefficient of metal and the linear expansion coefficient of ceramic. Therefore, in the insulating substrate 50, it is preferable that in particular at least one of the first and second stress buffer layers 52 and 54 among these constituent layers 51 to 55 is formed by the composite material 17 of this embodiment.

The composite material 17 of this embodiment can be regarded as a metal matrix composite material reinforced with carbon fibers 1 and has high Young's modulus. For this reason, it can be suitably used as a material for a member required to have high mechanical strength.

Next, each step will be described in detail below.

<Step S1 of Obtaining Coated Foil 12>

The coating liquid 5 used in this Step S1 is obtained, for example, as follows. As shown in FIG. 2, a large amount of carbon fibers 1, a binder 2, and a solvent 3 for the binder 2 are put in a mixing container 41, and they are stirred and mixed with a stirring and mixing apparatus 42. Thereby, a coating liquid 5 containing the carbon fibers 1, the binder 2, and the solvent 3 in a mixed state is obtained. At this time, a dispersant, an antifoaming agent, a surface conditioner, a viscosity modifier, etc., may be added to the mixing container 41 as necessary and stirred and mixed therein.

The stirring and mixing apparatus 42 is not specifically limited, and a stirring apparatus with stirring blades, a planetary mixer, a homodisper, a bead mill, etc., may be used.

The specific explanation of the carbon fiber 1, the binder 2, and the solvent 3 will be described later.

As a coating apparatus for applying the coating liquid 5, a gravure coating device (e.g., gravure coater) 20 is used.

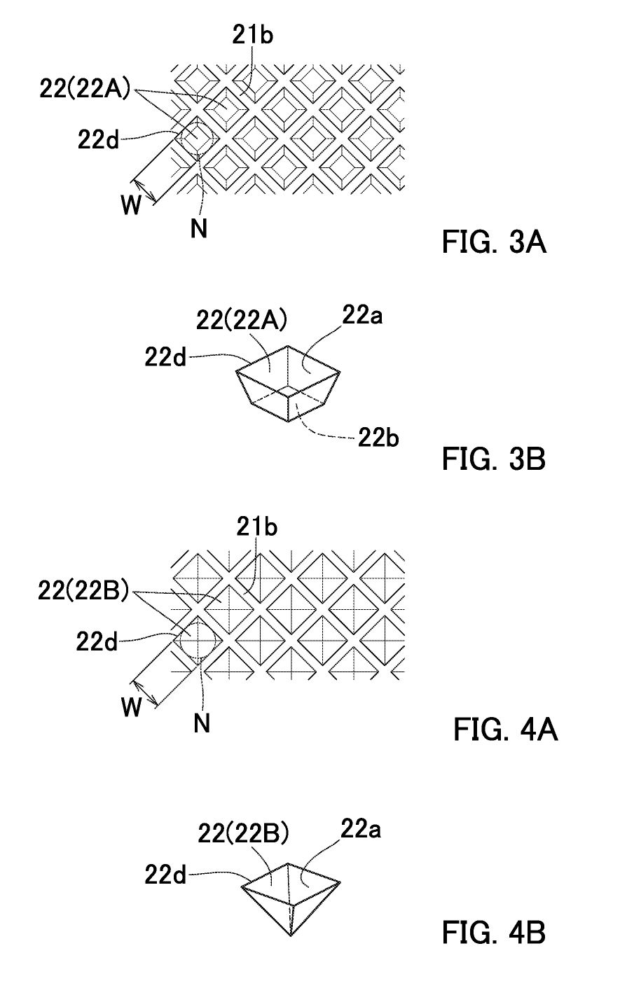

The gravure coating device 20 is specifically a direct gravure coating device (e.g., direct gravure coater), and is equipped with a gravure roll 21, a backup roll 23, a coating liquid applying means 25 for making the coating liquid 5 adhere to the circumferential surface 21a of the gravure roll 21, etc. On the entire circumferential surface 21a of the gravure roll 21, a large number of cells (recesses) 22 are provided in an orderly arranged manner (see FIGS. 3A, 4A, 5A, and 6A). A partition wall 21b is formed between adjacent cells 22, and each cell 22 is partitioned by this partition wall 21b. The backup roll 23 is arranged so as to face the gravure roll 21.

The coating liquid applying means 25 is provided with a coating liquid pan 26 containing the coating liquid 5 in this embodiment, and is configured to apply the coating liquid 5 to the circumferential surface 21a of the gravure roll 21 by rotating the gravure roll 21 about its central axis in a state in which a part of the circumferential direction of the circumferential surface 21a of the gravure roll 21 is immersed in the coating liquid 5 in the pan 26. The carbon fibers 1 in the coating liquid 5 in the pan 26 are dispersed in the coating liquid 5 so that its fiber directions are random.

In the gravure coating device 20 shown in FIG. 2, the strip member 10A of the metal foil 10 unwound from the unwinding roll 27a is wound by the winding roll 27b after sequentially passing through between the gravure roll 21 and the backup roll 23 and the inside of the drying furnace 28 as a drying apparatus at a predetermined feed rate approximately in the horizontal direction.

The feeding direction F of the strip member 10A of the metal foil 10 is set to the longitudinal direction of the strip member 10A of the metal foil 10. A direction parallel to the feeding direction F is the coating direction of the coating liquid 5 to the surface 10a of the strip member 10A of the metal foil 10 by the gravure coating device 20 (more specifically, the gravure roll 21 of the gravure coating device 20).

In this embodiment, the gravure roll 21 is arranged on the lower side of the strip member 10A of the metal foil 10 in such a manner so as to traverse the strip member 10A of the metal foil 10 entirely in the width direction, and the backup roll 23 is disposed on the upper side of the strip member 10A of the metal foil 10 in such a manner as to traverse the strip member 10A of the metal foil 10 entirely in the width direction. Therefore, the surface 10a of the strip member 10A of the metal foil 10 to which the coating liquid 5 is applied is the lower surface of the strip member 10A of the metal foil 10.

In the present invention, the surface 10a of the strip member 10A of the metal foil 10 to be coated by the coating liquid 5 is not limited to the lower surface of the strip member 10A of the metal foil 10. For example, it may be the upper surface of the strip member 10A of the metal foil 10 or the upper and lower surfaces of the strip member 10A of the metal foil 10.

The coating of the coating liquid 5 is performed when the strip member 10A of the metal foil 10 passes through between the gravure roll 21 and the backup roll 23. That is, as the gravure roll 21 rotates, the coating liquid 5 in the pan 26 adheres to the circumferential surface 21a of the gravure roll 21, and the coating liquid 5 enters each cell 22. Then, the excess coating liquid 5 adhered to the circumferential surface 21a of the gravure roll 21 is scraped off with the doctor blade (scraper) 24. Thereafter, the circumferential surface 21a of the gravure roll 21 comes into contact with the surface 10a of the strip member 10A of the metal foil 10, and the coating liquid 5 in the cell 22 is transferred to the surface 10a of the strip member 10A of the metal foil 10. As a result, the carbon fiber layer 11 composed of the transferred coating liquid 5 is formed over the entire surface 10a of the strip member 10A of the metal foil 10. Thus, a strip member 12A of the coated foil 12 having the carbon fiber layer 11 formed on the surface 10a of the strip member 10A of the metal foil 10 is obtained.

The rotational direction of the gravure roll 21 is normally set in the same direction as the feeding direction F of the strip member 10A of the metal foil 10. The peripheral velocity of the gravure roll 21 is usually set to equal to the feed rate of the strip member 10A of the metal foil 10.

The drying furnace 28 is configured to heat and dry the carbon fiber layer 11 formed on the surface 10a of the strip member 10A of the metal foil 10 (that is, the carbon fiber layer 11 of the strip member 12A of the coated foil 12) to cause evaporation of the solvent 3 contained in the carbon fiber layer 11 from the carbon fiber layer 11 to remove it.

In the gravure roll 21 of the gravure coating device 20, the shape of the cell 22 is a cup shape, and it is especially preferable that the shape of the cell 22 be a shape substantially closed around the entire circumference of the cell 22.

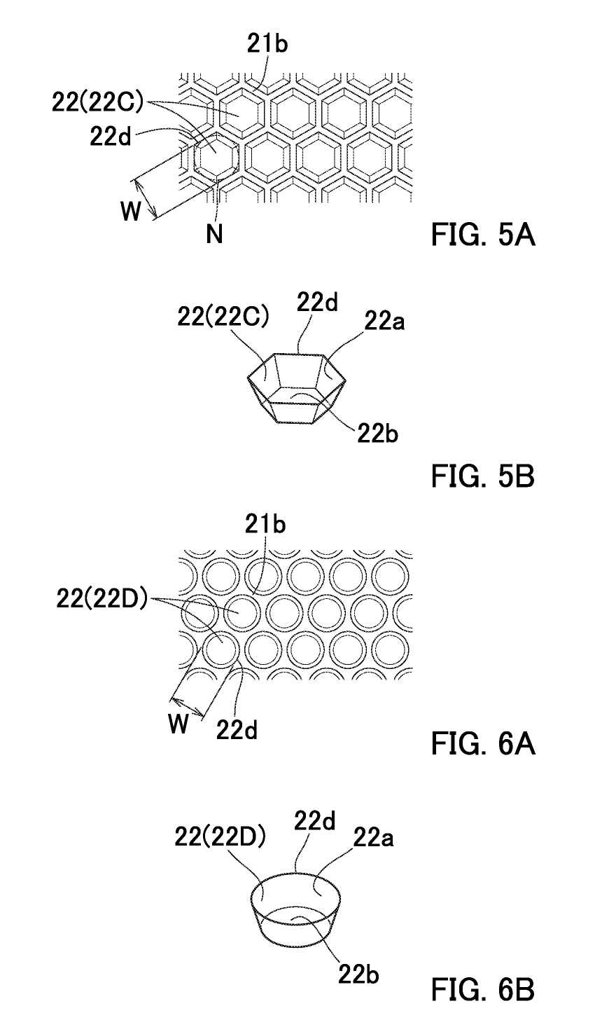

Specifically, the shape of the cell 22 is preferable at least one shape selected from the group consisting of a lattice shape 22A (see FIGS. 3A and 3B), a pyramid shape 22B (see FIGS. 4A and 4B), a hexagonal shape 22C (see FIGS. 5A and 5B), and a circular shape 22D (see FIGS. 6A and 6B).

The lattice shape cell 22A is formed to be recessed in the truncated quadrangular pyramid shape as shown in FIGS. 3A and 3B.

The pyramid shape cell 22B is formed to be recessed in the quadrangular pyramid shape as shown in FIGS. 4A and 4B.

The hexagonal shape cell 22C is formed to be recessed in the truncated hexagonal pyramid shape as shown in FIGS. 5A and 5B.

The circular shape cell 22D is formed to be recessed in the truncated cone shape as shown in FIGS. 6A and 6B.

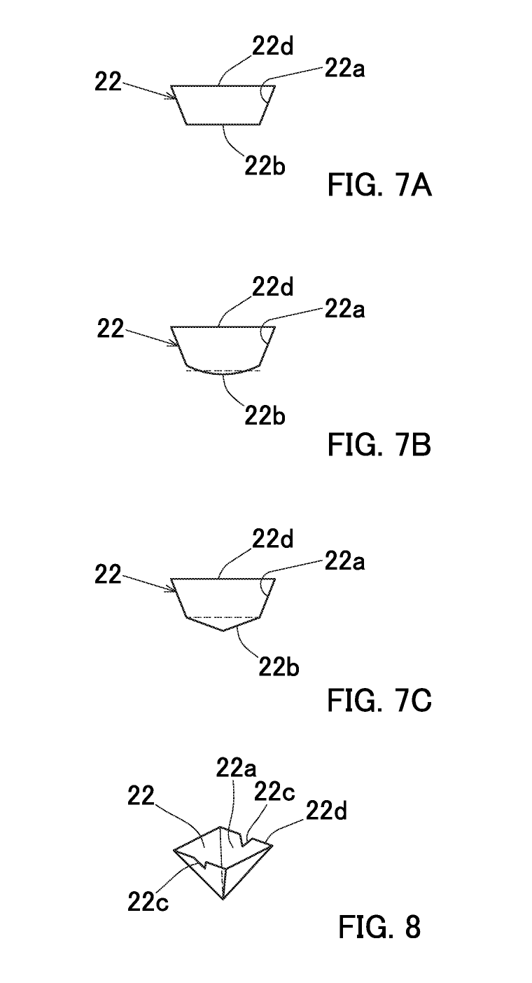

Furthermore, the shape of the bottom surface 22b of the cell 22 (e.g., a lattice shape, a pyramid shape, a hexagonal shape, a circular shape) is not limited. For example, it may be a flat shape as shown in FIG. 7A, a concave curved shape (e.g., a concave spherical shape) as shown in FIG. 7B, a concave conical shape (e.g., a concave pyramid shape, a concave conical shape) as shown in FIG. 7C, or a shape in which at least two of these shapes are combined.

Further, in this embodiment, it is preferable that the cell 22 have a shape in which the circumference of the cell 22 is completely closed over the entire circumference, but the present invention is not limited thereto. As shown in FIG. 8, the shape may be formed such that small communication ports 22c which allow a part of the coating liquid 5 in the cell 22 to flow into the adjacent cells 22 are formed in parts of the inner peripheral side surfaces 22a of the cell 22.

It is preferable that the size of the cell 22 be large enough for the carbon fiber 1 of the average fiber length to enter the cell 22 in a state substantially parallel to the opening surface of the cell 22 and for the carbon fiber 1 of the average fiber length contained in the cell 22 to be rotated by 360 degrees in the cell 22 in the inner circumferential direction of the cell 22. Specifically, it is preferable that the diameter W of the circle N (more specifically, circle N inscribed in the opening peripheral edge 22d of the cell 22) inscribed in the mouth shape of the cell 22 be set to 1.2 times or more the average fiber length of the carbon fiber 1.

In FIGS. 3A, 4A and 5A, the circle N inscribed in the mouth shape of the cell 22 is indicated by the two-dot chain line. In FIG. 6A, the circle N inscribed in the mouth shape of the cell 22 matches the opening peripheral edge 22d of the cell 22.

As described above, the shape of the cell 22 is a cup shape and the diameter W of the circle N inscribed in the mouth shape of the cell 22 is set to 1.2 times or more the average fiber length of the carbon fiber 1. For this reason, when the coating liquid 5 in the pan 26 is adhered to the circumferential surface 21a of the gravure roll 21 (that is, when the circumferential surface 21a of the gravure roll 21 is immersed in the coating liquid 5 in the pan 26), the coating liquid 5 enters the cell 22 so that the fiber directions of the carbon fibers 1 in the coating liquid 5 become random in the inner circumferential direction of the cell 22. The carbon fiber 1 in the coating liquid 5 contained in the cell 22 can rotate in the inner circumferential direction of the cell 22. In this state, as the gravure roll 21 rotates, the coating liquid 5 in the cell 22 is transferred to the surface 10a of the strip member 10A of the metal foil 10. As a result, the carbon fiber layer 11 is formed on the surface 10a of the strip member 10A of the metal foil 10 so that the fiber directions of the carbon fibers 1 in the surface 10a of the strip member 10A of the metal foil 10 become random.

On the other hand, in cases where the shape of the cell 22 is not a cup shape but an oblique line type (not shown) well known as the shape of the cell 22, when the coating liquid 5 in the pan 26 is adhered to the circumferential surface 21a of the gravure roll 21, the coating liquid 5 is likely to enter the cell 22 so that the fiber directions of the carbon fibers 1 in the coating liquid 5 are aligned in one direction along the oblique line direction of the cell 22. In this state, as the gravure roll 21 rotates, the coating liquid 5 in the cell 22 is transferred to the surface 10a of the strip member 10A of the metal foil 10. As a result, the fiber directions of the carbon fibers 1 in the surface 10a of the strip member 10A of the metal foil 10 do not become random but become likely to be aligned in one direction. Therefore, the shape of the cell 22 must be a cup shape, not an oblique line shape.

The upper limit of the diameter W of the circle N inscribed in the mouth shape of the cell 22 is not limited, but is, for example, 2,500 μm.

In cases where the shape of the opening peripheral edge 22d of the cell 22 is a square shape (e.g., a lattice shape 22A, a pyramid shape 22B), it is preferable that the diameter W of the circle N inscribed in the mouth shape of the cell 22 be larger than that when the shape of the cell 22 is a hexagonal shape 22C or a circular shape 22D. In particular, it is especially preferable that it be 1.5 times or more the average fiber length of the carbon fiber 1.

In a state after the carbon fiber layer 11 is formed on the surface 10a of the strip member 10A of the metal foil 10 by the gravure roll 21 and before the strip member 10A of the metal foil 10 (the strip member 12A of the coated foil 12) enters the drying furnace 28 (that is, before Step S1a of removing the solvent 3 from the carbon fiber layer 11), it is preferable that the surface of the carbon fiber layer 11 be not subjected to slide leveling processing for flattening the surface.

The slide leveling processing denotes processing of flattening the surface of the carbon fiber layer 11 by sliding the surface of the carbon fiber layer 11 with the end edge peripheral portion of a slide leveling member by feeding the strip member 10A of the metal foil 10 in the feeding direction F relative to the slide leveling member in a state in which the end edge peripheral portion of the slide leveling member (e.g., slide leveling plate) is in contact with the surface of the carbon fiber layer 11 in the direction crossing the feeding direction F of the strip member 10A of the metal foil 10 (e.g., perpendicular direction).

When this slide leveling processing is applied to the surface of the carbon fiber layer 11, the fiber directions of the carbon fibers 1 in the carbon fiber layer 11 tend to be aligned in the direction along the end edge peripheral portion of the slide leveling member. Therefore, it is preferable not to apply the slide leveling processing to the surface of the carbon fiber layer 11 as much as possible. In cases where the slide leveling processing is not applied to the surface of the carbon fiber layer 11, it is possible to assuredly maintain the fiber direction of the carbon fiber 1 in the carbon fiber layer 11 in the surface 10a of the strip member 10A of the metal foil 10 in a random state. With this, it is possible to assuredly equalize the physical properties of the composite material 17 in the planar direction thereof.

The carbon fiber 1 can be used as long as it is a fibrous carbon particle. Specifically, for example, one of carbon fibers or two or more mixed carbon fibers selected from the group consisting of a PAN-based carbon fiber, a pitch-based carbon fiber, and a carbon nanofiber (e.g., a vapor-phase growth carbon fiber, a carbon nanotube) can be used.

Among a PAN-based carbon fiber and a pitch-based carbon fiber, it is particularly preferable to use a pitch-based carbon fiber. The reason is that the thermal conductivity of the pitch-based carbon fiber in the fiber direction is greater than that of the PAN-based carbon fiber, so that a composite material 17 having higher thermal conductivity can be obtained.

The length of the carbon fiber 1 is not limited, and it is particularly preferable that the average fiber length of carbon fiber 1 be 1 mm or less. The reason is that the carbon fiber layer 11 can be formed on the surface 10a of the strip member 10A of the metal foil 10 so that the fiber directions of the carbon fibers 1 in the surface 10a of the strip member 10A of the metal foil 10 become random assuredly. With this, it is possible to more assuredly equalize the physical properties of the composite material 17 in the planar direction.

The lower limit of the length of carbon fiber 1 is not limited. Usually, the lower limit of the average fiber length of the carbon fiber 1 is 10 μm.

The fiber diameter of the carbon fiber 1 is not limited. The average fiber diameter of the carbon fibers 1 is, for example, 0.1 nm to 20 μm. In cases where the carbon fiber 1 is a PAN-based carbon fiber or a pitch-based carbon fiber, the carbon fiber 1 is, for example, a chopped fiber or a milled fiber and its average fiber diameter is, for example, 5 μm to 15 μm. In cases where the carbon fiber 1 is a vapor-phase growth nano-carbon fiber, the average fiber diameter of the carbon fiber 1 is, for example, 0.1 nm to 20 μm.

The binder 2 is used to impart an adhesion force to the carbon fiber 1 to the surface 10a of the strip member 10A of the metal foil 10 to thereby suppress the carbon fiber 1 in the carbon fiber layer 11 from falling off from the surface 10a of the strip member 10A of the metal foil 10, and is usually made of resin.

Furthermore, the binder 2 is likely to become a sintered residue or an amorphous carbide of an organic substance when heated, and they become a factor to lower the thermal conductivity of the composite material 17 as a residue of the binder 2. For this reason, it is preferable to use a binder 2 which does not carbonize at a temperature of 200° C. to 450° C. in a non-oxidizing atmosphere but disappears by sublimation or decomposition. As such a binder 2, an acryl based resin, a polyethylene glycol based resin, a butylene rubber resin, a phenol resin, a cell loose based resin or the like is suitably used. These binders 2 are generally solid at ambient temperature.

The solvent 3 is preferably a solvent that dissolves the binder 2 at room temperature. As the solvent, water, an alcohol based solvent, a hydrocarbon based solvent, an ester based solvent, an ether based solvent, etc., are preferably used.

The coating liquid 5 preferably contains the carbon fiber 1 and the binder 2 in a mass ratio of 75:25 to 99.5:0.5. In this case, the carbon fiber 1 can be assuredly attached to the surface 10a of the strip member 10A of the metal foil 10 in Step S1 of obtaining the coated foil 12, and in Step S3a of removing the binder 2, the binder 2 can be assuredly eliminated and removed. It is particularly preferable that the coating liquid 5 contains the carbon fiber 1 and the binder 2 in a mass ratio of 80:20 to 99:1.

In Step S1 of obtaining the coated foil 12, it is preferable to apply the coating liquid 5 to the surface 10a of the strip member 10A of the metal foil 10 so that the coating amount of the carbon fiber 1 contained in the carbon fiber layer 11 is 40 g/m² or less. The reason is as follows.

That is, when the coating liquid 5 is applied to the surface 10a of the strip member 10A of the metal foil 10 so that the coating amount of the carbon fiber 1 contained in the carbon fiber layer 11 is 40 g/m² or less, in Step S3 of integrally sintering the coated foils 12, the metal of the metal foil 10 sufficiently penetrates into almost all of the cavities in the carbon fiber layer 11 and both metal foils 10 and 10 disposed on both sides of the carbon fiber layer 11 are sufficiently sintered. With this, the strength (mechanical strength, etc.) of the composite material 17 can be assuredly enhanced. Further, in order to shorten the production time of the composite material 17, it is particularly preferable that the coating amount of the carbon fiber 1 contained in the carbon fiber layer 11 be 30 g/m² or less.

It is preferable to apply the coating liquid 5 to the surface 10a of the strip member 10A of the metal foil 10 so that the volume of the carbon fibers 1 in the obtained composite material 17 is less than 50% of the entire volume of the composite material 17. With this, in Step S3 of integrally sintering the coated foils 12, the metal of the metal foil 10 can be assuredly impregnated into the carbon fiber layer 11, which can assuredly integrally sinter the coated foils 12.

Here, in cases where the composite material 17 is used as the material of the first stress buffer layer 52 of the insulating substrate 50 shown in FIG. 15, it is preferable to set the ratio between the volume of the metal foil 10 and the volume of the carbon fiber 1 so that the linear expansion coefficient of the composite material 17 in the planar direction becomes an intermediate value between the linear expansion coefficient of the ceramic layer 53 of the insulating substrate 50 and the linear expansion coefficient of the wiring layer 51.

Further, in cases where the composite material 17 is used as the material of the second stress buffer layer 54 of the insulating substrate 50, it is preferable to set the ratio between the volume of the metal foil 10 and the volume of the carbon fibers 1 so that the linear expansion coefficient of the composite material 17 in the planar direction becomes an intermediate value between the linear expansion coefficient of the ceramic layer 53 of the insulating substrate 50 and the linear expansion coefficient of the cooling layer 55.

In cases where the metal foil 10 is, for example, an aluminum foil, in particular, in order to set the linear expansion coefficient of the composite material 17 in the planar direction to an intermediate value (about 10×10⁻⁶/K to 16×10⁻⁶/K) between the linear expansion coefficient (e.g., about 3×10⁻⁶/K to 5×10⁻⁶/K) of a ceramic (aluminum nitride, alumina, silicon carbide, etc.) which is often used as the material of the ceramic layer 53 and the linear expansion coefficient (about 23×10⁻⁶/K) of aluminum which is often used as the material of the cooling layer 55, it is preferable to set the volume of the carbon fibers 1 to 10% or more and less than 50% with respect to the entire volume of the composite material 17.

The metal foil 10 (the strip member 10A of the metal foil 10) is not limited to the material as long as it can withstand the coating. In particular, the metal foil 10 is preferably at least one of an aluminum foil and a copper foil. The reason is that a composite material 17 having high thermal conductivity can be assuredly obtained.

In the case where the metal foil 10 is an aluminum foil, the material of the aluminum foil is not limited, and an A1000 series aluminum alloy, an A3000 series aluminum alloy, an A6000 series aluminum alloy, and the like are used. In general, the material of the aluminum foil is appropriately selected from plural kinds of aluminum materials so that the physical properties (thermal conductivity, linear expansion coefficient, etc.) of the composite material 17 to be obtained become desired set values.

In the case where the metal foil 10 is a copper foil, the kind and the material of the copper foil are not limited, and an electrolytic copper foil, a rolled copper foil and the like are used. In general, the material of the copper foil is appropriately selected from plural kinds of copper materials so that the physical properties of the composite material 17 to be obtained become desired set values.

The thickness of the metal foil 10 is not limited, and the thickness of the metal foil 10 can be selected so that the physical properties of the composite material 17 to be obtained become desired set values.

Here, the thinnest thickness of a commercially available metal foil (aluminum foil, copper foil) 10 is 6 μm. For this reason, the lower limit of the thickness of the metal foil 10 is particularly preferable from the view point that the metal foil 10 is readily available because the lower limit thereof is 6 μm. The upper limit of the thickness of the metal foil 10 is usually 100 μm, and it is particularly preferable that the upper limit be approximately 50 μm.

The width of the metal foil 10 is not limited, and is set in accordance with the use of the composite material 17. For example, it is set to 10 mm to 1,200 mm.

As shown in FIG. 2, Step S1a of removing the solvent 3 is performed by passing the strip member 12A of the coated foil 12 through the drying furnace 28 as shown in FIG. 2. That is, when the strip member 12A of the coated foil 12 passes through the drying furnace 28, the carbon fiber layer 11 is heated by the drying furnace 28 and dried. As a result, the solvent 3 contained in the carbon fiber layer 11 is evaporated and removed from the carbon fiber layer 11. After that, the strip member 12A of the coated foil 12 is wound up on the winding roll 27b.

The conditions for removing the solvent 3 by the drying furnace 28 are not limited as long as the solvent 3 contained in the carbon fiber layer 11 can be evaporated and removed from the carbon fiber layer 11. Normally, drying conditions of a drying temperature of 60° C. to 250° C. and a drying time of 1 minute to 120 minutes can be applied as the conditions for removing the solvent 3.

Furthermore, after removing the solvent 3, large cavities may be sometimes formed in the carbon fiber layer 11. Therefore, it is also possible to increase the bulk density of the carbon fiber layer 11 by pressurizing the carbon fiber layer 11 in the thickness direction with pressure rolls (not shown).

<Step S2 of Forming Laminate 15>

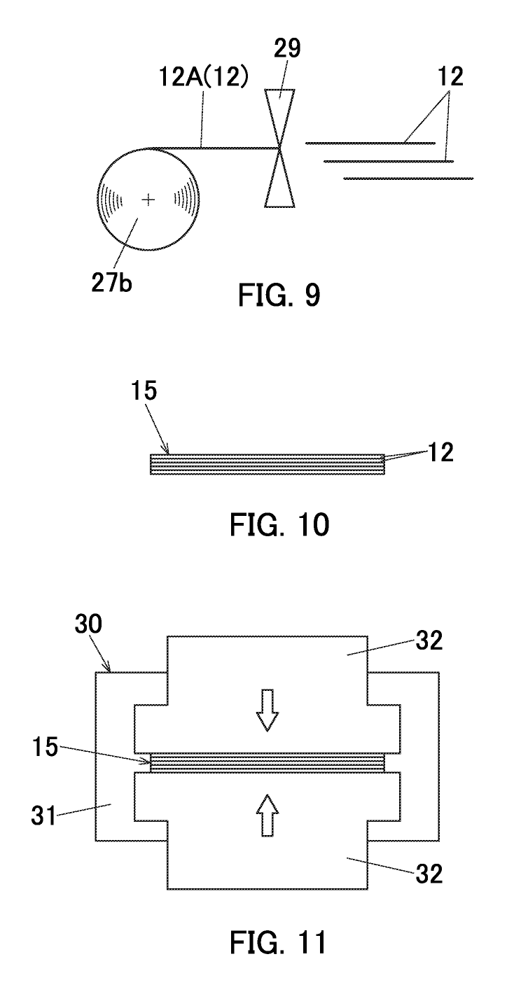

In the step of forming the laminate 15, as shown in FIG. 9, the strip member 12A of the coated foil 12 unwound from the winding roll 27b is cut into a predetermined shape with a cutting machine 29. With this, a plurality of coated foils 12 each having a predetermined shape (e.g., approximately rectangular shape) is cut out from the strip member 12A of the coated foil 12. Then, as shown in FIG. 10, by laminating a plurality of coated foils 12, a laminate 15 in which the plurality of coated foils 12 is laminated is formed. Alternatively, although not shown, the strip member 12A of the coated foil 12 unwound from the winding roll 27b may be rolled so as to form a laminate 15 in which a plurality of coated foils 12 is laminated.

The laminate 15 thus formed is used as a preform (sintered material).

The lamination number of the coated foils 12 is not limited, and is set in accordance with the thickness of the desired composite material 17. For example, it is set to 5 to 1,000 sheets.

<Step S3 of Integrally Sintering Coated Foils 12>

In Step S3 of integrally sintering the coated foils 12, as shown in FIG. 11, the laminate 15 is arranged in a sintering chamber 31 of a sintering apparatus (joining device) 30 such as a pressure heating sintering machine. Then, the sintering apparatus 30 heats the laminate 15 at a predetermined sintering temperature while pressurizing the laminate 15 in the lamination direction of the coated foils 12 (that is, the thickness direction of the laminate 15) in a predetermined sintering atmosphere to thereby sinter the laminate 15, i.e., integrally sinter the coated foils 12. As a result, a composite material 17 of this embodiment is obtained as shown in FIG. 13.

In this Step S3, the laminate 15 is pressurized and heated, so that the carbon fiber layer 11 is compressed in its thickness direction. With this, a part of the metal of the metal foil 10 permeates into the carbon fiber layer 11 and flows into fine cavities existing in the carbon fiber layer 11 (e.g., a gap between the carbon fibers 1 in the carbon fiber layer 11). As a result, the cavities substantially disappear. As a result, the density of the composite material 17 to be obtained can be made 95% or more of the theoretical density of the composite material 17.

Note that the theoretical density of the composite material 17 means the density of the composite material 17 in the case where the composite material 17 is made only of the metal of the metal foil 10 and the carbon fibers 1 and the cavities do not exist at all inside the composite material 17.

As the sintering apparatus 30, a hot pressing machine (e.g., vacuum hot press machine), a spark plasma sintering apparatus or the like is preferably used.

The pressurization to the laminate 15 is performed by, for example, pressurizing the laminate 15 with a pair of punches 32 and 32 provided in the sintering apparatus 30.

The sintering atmosphere is preferably a non-oxidizing atmosphere. The non-oxidizing atmosphere includes an inert gas atmosphere (e.g., a nitrogen gas atmosphere, an argon gas atmosphere), a vacuum atmosphere, etc.

The sintering temperature means a temperature at which the coated foils 12 are integrally sintered (integrally joined). Specifically, the sintering temperature is set to a temperature equal to or lower than the melting point of the metal of the metal foil 10. In particular, the sintering temperature is preferably set to a temperature between the melting point of the metal of the metal foil 10 and a temperature lower than the melting point by about 50° C. from the viewpoint that the coated foils 12 can be assuredly integrally sintered. In cases where the metal foil 10 is, for example, an aluminum foil, the sintering temperature is preferably set within the range of 550° C. to 620° C.

The pressure applied to the laminate 15 is not limited, and may be a pressurizing force to the extent of lightly pressing the laminate 15. Further, when the laminate 15 is pressurized at the time of applying heat to the laminate 15, the fluidity of the metal of the metal foil 10 may sometimes be improved. Therefore, it is especially preferable to pressurize the laminate 15 with a pressurizing force to such an extent that the metal of the metal foil 10 does not flow out of the laminate 15 by the pressurization to the laminate 15 or to pressurize the laminate 15 in a die (not shown) so that the metal of the metal foil 10 does not flow out of the laminate 15.

If the coated foils 12 are integrally sintered in a state in which cavities remain between the coated foils 12, the cavity portion becomes an internal defect of the composite material 17. Therefore, in order to suppress occurrence of this defect, it is preferable to pressurize the laminate 15 in a vacuum atmosphere as a sintering atmosphere and/or to pressurize the laminate 15 in a die.

In this embodiment, Step S3a of removing the binder 2 is performed by the sintering apparatus 30 in the middle of heating the laminate 15 in Step S3 of integrally sintering the coated foils 12 by the sintering apparatus 30 from about room temperature as the initial temperature to the sintering temperature. Step S3a of removing the binder 2 in this case will be described below.

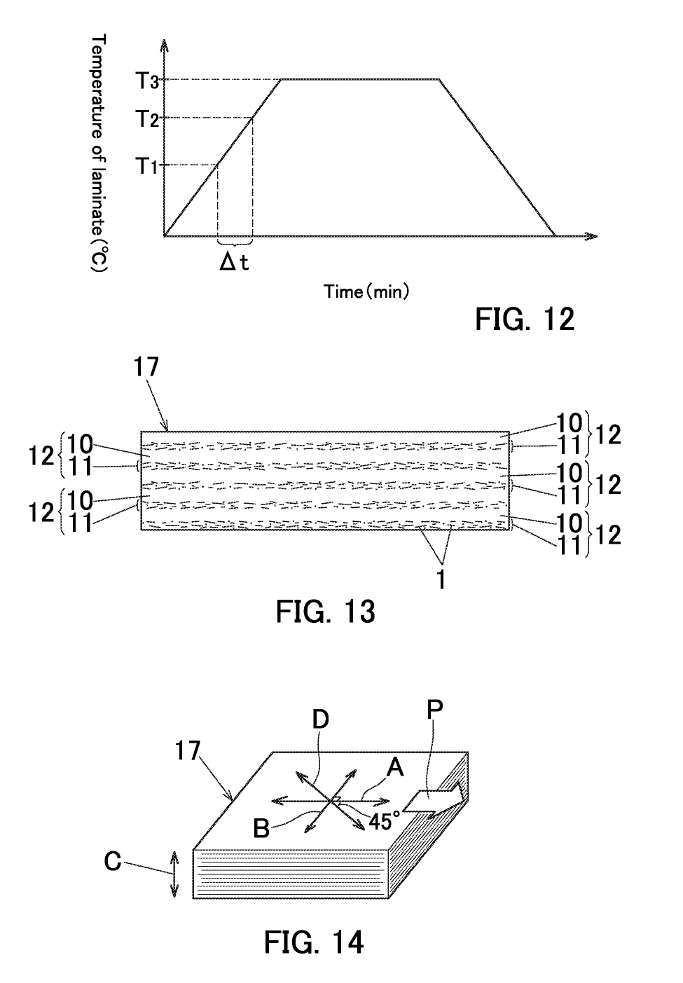

FIG. 12 is a figure (graph) showing an example of a temperature curve when heating the laminate 15 in Step S3 of integrally sintering the coated foils 12.

The temperature range from T1 to T2 (T1<T2) in the figure is a range in which the binder 2 contained in the carbon fiber layers 11 of the coated foils 12 of the laminate 15 disappear by sublimation or decomposition, and is usually 200° C. to 450° C. T3 is the sintering temperature, which is higher than T2 (i.e., T3>T2).

In Step S3 of integrally sintering the coated foils 12, when the temperature of the laminate 15 in the middle of heating the laminate 15 by the sintering apparatus 30 so that the temperature of the laminate 15 rises from about room temperature to the sintering temperature T3 is within the range of T1 to T2, the binder 2 disappears by sublimation or decomposition and is removed from the laminate 15 (more specifically, the carbon fiber layer 11 of the coated foil 12 of the laminate 15).

The time Δt during which the temperature of the laminate 15 is within the temperature range from T1 to T2 is not limited as long as it is a time period capable of removing the binder 2 from the laminate 15, and is set according to the temperature rising rate of the laminate 15 by the sintering apparatus 30, the total amount of the binder 2 contained in the laminate 15, the thickness of the laminate 15 (e.g., the lamination number of the coated foil 12), the sintering atmosphere, etc. Usually, the time is set to 10 minutes or more.

Further, when the temperature of the laminate 15 is within the temperature range of T1 to T2, the time Δt may be extended by temporarily stopping the temperature rising or moderating the temperature rising rate, which can assuredly remove the binder 2.

As described above, by performing Step S3a of removing the binder 2 in the middle of heating the laminate 15 in Step S3 of integrally sintering the coated foils 12 up to the sintering temperature T3, the number of production steps of the composite material 17 can be easily reduced, which in turn enables easy production of the composite material 17.

Note that the present invention does not exclude that Step S3a of removing the binder 2 is performed independently of Step S3 of integrally sintering (integrally joining) the coated foils 12 by the sintering apparatus 30.

In this case, Step S3a of removing the binder 2 is preferably performed after Step S2 of forming the laminate 15 and before Step S3 of integrally sintering (integrally joining) the coated foils 12. The reason is that the carbon fibers 1 in the carbon fiber layer 11 can be assuredly prevented from falling off from the surface 10a of the metal foil 10 at the time of forming the laminate 15. Further, in this case, after performing Step S3a of removing the binder 2 and before performing Step S3 of integrally sintering the coated foils 12, it is preferable to place the laminate 15 in a non-oxidizing atmosphere and/or to set the temperature of the laminate 15 at 300° C. or lower. The reason is that the oxidation consumption of the carbon fibers 1 can be assuredly suppressed and the oxidation of the aluminum foil can be assuredly suppressed when the metal foil 10 is an aluminum foil.

In this embodiment, as described above, the coating apparatus for applying the coating liquid 5 on the surface 10a of the strip member 10A of the metal foil 10 is a gravure coating device 20, the shape of the cell 22 of the gravure roll 21 of the gravure coating device 20 is a cup shape, and the diameter W of the circle N inscribed in the mouth shape of cell 22 is set to 1.2 times or more the average fiber length of the carbon fiber 1. With this, it is possible to form the carbon fiber layer 11 on the surface 10a of the strip member 10A of the metal foil 10 so that the fiber directions of the carbon fibers 1 in the surface 10a of the strip member 10A of the metal foil 10 become random. Therefore, it is possible to equalize the physical properties (thermal conductivity, linear expansion coefficient, etc.) of the composite material 17 in the planar direction.

Further, it is unnecessary to consider the fiber directions of the carbon fibers 1 when forming the laminate 15, so that the equalization of the physical properties of the composite material 17 in the planar direction can be easily achieved.

Here, the arrow “P” in FIG. 14 indicates the coating direction of the coating liquid 5 to the surface 10a of the strip member 10A of the metal foil 10 by the gravure coating device 20. In this embodiment, the longitudinal direction A of the composite material 17 means a direction parallel to the coating direction P. The width direction B of the composite material 17 means a direction perpendicular to the longitudinal direction A of the composite material 17 in the planar of the composite material 17. The oblique direction D of the composite material 17 means a direction oblique to the longitudinal direction A of the composite material 17 at 45° in the planar of the composite material 17. The symbol “C” denotes a thickness direction of the composite material 17, and this thickness direction D coincides with the lamination direction of the coated foil 12.

As shown in FIG. 14, in the composite material 17 of this embodiment, the physical properties of the composite material 17 in the longitudinal direction A, the physical properties of the composite material 17 in the width direction B, and the physical properties of the composite material 17 in the oblique direction D are substantially equal to each other. Therefore, in the insulating substrate 50 shown in FIG. 15, by forming at least one constituent layer among the plurality of constituent layers 51 to 55 constituting the insulating substrate 50 with the composite material 17, an insulating substrate 50 having high reliability with respect to the temperature changes such as a cold heat cycle can be obtained. Therefore, it is possible to assuredly suppress occurrence of cracking and peeling of the insulating substrate 50 due to thermal strain.

On the other hand, in cases where the coating apparatus is not a gravure coating device 20 but a roll coating apparatus (e.g., a roll coater), a die coating apparatus (e.g., a die coater) or a knife coating apparatus (e.g., a knife coater), the fiber directions of the carbon fibers 1 in the surface 10a of the strip member 10A of the metal foil 10 are easily aligned in one direction. For this reason, it is very hard to equalize the physical properties of the composite material 17 in the planar direction.

Although an embodiment of the present invention is described above, the present invention is not limited to the aforementioned embodiment, and various modifications can be made within the scope not departing from the gist of the present invention.

In the present invention, the metal foil to which the coating liquid is applied in the step of obtaining the coated foil is not limited to the strip member of the metal foil as shown in the aforementioned embodiment. For example, it may be a metal foil (for example, a substantially rectangular metal foil having a preset length dimension and width dimension) which is not like a strip member.

Further, in the present invention, it is particularly preferable that the gravure coating device be a direct gravure coating device as shown in the aforementioned embodiment. However, other than the above, for example, it may be an offset gravure coating device (e.g., an offset gravure coater).

### EXAMPLES

Next, specific examples and comparative examples of the present invention will be described below. It should be noted that the present invention is not limited to the examples shown below.

### Example 1

In Example 1, an aluminum-carbon fiber composite material was produced by the following procedure.

Carbon fibers having an average fiber length of 150 μm and an average fiber diameter of 10 μm (XN-100 manufactured by Nippon Graphite Fiber Co., Ltd.), a 3 mass % aqueous solution of polyethylene oxide (Alcox (registered trademark) E-45 manufactured by Meisei Chemical Industry Co., Ltd.) having an average molecular weight of 700,000 as a binder, an isopropyl alcohol as a solvent, water, a dispersant, and a surface conditioner were stirred and mixed, whereby a coating liquid was obtained. The mass of the binder contained in the coating liquid was 10% in terms of solid contents with respect to the mass of carbon fibers. The viscosity of the coating liquid was 1,000 mPa·s at 25° C.

The coating liquid was applied to the entire lower surface of a belt-like strip member of an aluminum foil (its material: A1N30) having a thickness of 20 μm and a width of 500 mm by a gravure coater (more specifically, a direct gravure coater) at a coating rate of 20 m/min. With this, a coated foil strip member with a carbon fiber layer formed on the lower surface of the aluminum foil strip member was obtained. Then, the solvent was removed from the carbon fiber layer by passing the strip member of the coated foil through the drying furnace. The coating amount of the carbon fibers contained in the carbon fiber layer after removing the solvent from the carbon fiber layer was 30 g/m².

The composition of the gravure coater was as follows.

The mesh of the circumferential surface of the gravure roll provided in the gravure coater was #25, the cell shape was a lattice shape, and the diameter of the circle inscribed in the mouth shape of the cell was 1,000 μm.

Conditions for removing the solvent by the drying furnace were a drying temperature of 180° C. and a drying time of 2 minutes.

Next, the strip member of the coated foil was cut into a square shape (its size: length 50 mm×width 50 mm). With this, a plurality of square shaped coated foils was cut out from the strip member of the coated foil. Then, a laminate was formed by laminating 200 sheets of the coated foils.

Next, the laminate was sintered, i.e., the coated foils were integrally sintered, by applying heat to the laminate at a predetermined sintering temperature while pressurizing the laminate in the lamination direction in the vacuum atmosphere by a spark plasma sintering apparatus as a pressure heating sintering machine. Thus, an aluminum-carbon fiber composite material was obtained. The thickness of the composite material was 4 mm.

The sintering conditions applied to this sintering were as follows.

The sintering temperature was 550° C., the retention time (sintering time) of the sintering temperature was 3 hours, the temperature rising rate from room temperature was 50° C./min, the applied pressure to the laminate was 15 MPa, and the degree of vacuum was 5 Pa.

Further, in the step of integrally sintering the coated foils as described above, the temperature rising was temporarily stopped in the middle of heating the laminate from room temperature to the sintering temperature of 550° C., and the binder was removed from the laminate. The removal condition of the binder applied at this time was as follows.

The heating temperature of the laminate for removing the binder was 380° C., and the heating time was 30 min.

In the obtained composite material, a plurality of aluminum layers formed from the aluminum foils and carbon fiber layers were alternately laminated, furthermore, the aluminum was sufficiently penetrated into the carbon fiber layers, almost no cavities existed in the carbon fiber layers, and the density of the composite material was 99% of the theoretical density of the composite material.

### Example 2

In Example 2, an aluminum-carbon fiber composite material was produced by the following procedure.

Carbon fibers having an average fiber length of 200 μm and an average fiber diameter of 10 μm (K223HM manufactured by Mitsubishi Plastics, Inc.), an acryl based resin as a binder, a propylene glycol ethyl ether acetate as a solvent, a dispersant, and a surface conditioner were stirred and mixed. Thus, a coating liquid was obtained. The mass of the binder contained in the coating liquid was 20% in terms of solid contents with respect to the mass of carbon fibers. The viscosity of the coating liquid was 700 mPa·s at 25° C.

The coating liquid was applied to the entire lower surface of the belt-like strip member of the aluminum foil (its material: A1N30) having a thickness of 20 μm and a width of 280 mm by a gravure coater at a coating rate of 30 m/min. With this, a coated foil strip member with a carbon fiber layer formed on the lower surface of the aluminum foil strip member was obtained. Then, the solvent was removed from the carbon fiber layer by passing the strip member of the coated foil through the drying furnace. The coating amount of the carbon fibers contained in the carbon fiber layer after removing the solvent from the carbon fiber layer was 20 g/m².

The configuration of the gravure coater was as follows.

The mesh of the circumferential surface of the gravure roll provided in the gravure coater was #30, the cell shape was a pyramid shape, and the diameter of the circle inscribed in the mouth shape of the cell was 830 μm.

Conditions for removing the solvent by the drying furnace were a drying temperature of 170° C. and a drying time of 1 minute.

Next, the strip member of the coated foil was cut into a square shape (its size: length 50 mm×width 50 mm). With this, a plurality of square shaped coated foils was cut out from the strip member of the coated foil. Then, a laminate was formed by laminating 200 sheets of the coated foils.

Next, the laminate was sintered, i.e., the coated foils were integrally sintered, by applying heat to the laminate at a predetermined sintering temperature while pressurizing the laminate in the lamination direction in a vacuum atmosphere by a vacuum hot press machine as a pressure heating sintering machine. Thus, an aluminum-carbon fiber composite material was obtained. The thickness of the composite material was 4 mm.

The sintering conditions applied to this sintering were as follows.

The sintering temperature was 600° C., the retention time (sintering time) of the sintering temperature was 6 hours, the temperature rising rate from room temperature was 20° C./min., the applied pressure to the laminate was 15 MPa, and the degree of vacuum was 5×10⁻¹ Pa.

In the step of integrally sintering the coated foils as described above, the temperature rising rate (20° C./min.) from room temperature was slower than that of Example 1 (50° C./min.), and in the middle of heating the laminate from room temperature to the sintering temperature of 600° C., the temperature rising was not stopped temporarily. Nevertheless, the binder was removed from the laminate.

In the obtained composite material, a plurality of aluminum layers formed from the aluminum foils and carbon fiber layers were alternately laminated, furthermore, the aluminum was sufficiently penetrated into the carbon fiber layers, almost no cavities existed in the carbon fiber layers, and the density of the composite material was 99% of the theoretical density of the composite material.

### Comparative Example 1

In Comparative Example 1, an aluminum-carbon fiber composite material was produced by the following procedure.

The same coating liquid as the coating liquid used in Example 1 was prepared. Then, the coating liquid was applied to the entire lower surface of the strip member of the aluminum foil (its material: A1N30) having a thickness of 20 μm and a width of 150 mm with a testing applicator. With this, a coated foil strip member with a carbon fiber layer formed on the lower surface of the aluminum foil strip member was obtained. Then, the solvent was removed from the carbon fiber layer by passing the strip member of the coated foil through the drying furnace. The coating amount of the carbon fibers contained in the carbon fiber layer after removing the solvent from the carbon fiber layer was 30 g/m².

Conditions for removing the solvent by the drying furnace were a drying temperature of 100° C. and a drying time of 30 minutes.

Next, the strip member of the coated foil was cut into a square shape (its size: length 50 mm×width 50 mm). With this, a plurality of square shaped coated foils was cut out from the strip member of the coated foil. Then, a laminate was formed by laminating 200 sheets of the coated foils with all the coating directions aligned.

Next, the laminate was sintered, i.e., the coated foils were integrally sintered, by applying heat to the laminate at a predetermined sintering temperature while pressurizing the laminate in the lamination direction in a vacuum atmosphere by a spark plasma sintering apparatus as a pressure heating sintering apparatus. Thus, an aluminum-carbon fiber composite material was obtained. The thickness of the composite material was 4 mm.

The sintering conditions and the binder removal conditions applied to this sintering were the same as those in Example 1 described above.

In the obtained composite material, a plurality of aluminum layers formed from the aluminum foils and carbon fiber layers were alternately laminated, furthermore, the aluminum was sufficiently penetrated into the carbon fiber layers, almost no cavities existed in the carbon fiber layers, and the density of the composite material was 99% of the theoretical density of the composite material.

### Comparative Example 2

In Comparative Example 2, an aluminum-carbon fiber composite material was obtained in the same production steps and production conditions as those in Comparative Example 1 except that the laminate was formed by laminating 200 sheets of coated foils so that the coating directions were alternately perpendicular to each other.

In the obtained composite material, a plurality of aluminum layers formed from the aluminum foils and carbon fiber layers were alternately laminated, furthermore, the aluminum was sufficiently penetrated into the carbon fiber layers, almost no cavities existed in the carbon fiber layers, and the density of the composite material was 99% of the theoretical density of the composite material.

<Measurement of Physical Properties>

As to the composite materials of Examples 1 and 2 and Comparative Examples 1 and 2, the thermal conductivity and the linear expansion coefficient were measured, respectively. The results are shown in Table 1.

TABLE 1

| | Thermal | | | | Linear expansion | | | | |
|---|---|---|---|---|---|---|---|---|---|
| | conductivity | | | | coefficient | | | | Presence or |
| | (W/(m · K)) | | | | (×10⁻⁶/K) | | | | absence of |
| | A* | B* | C* | D* | A* | B* | C* | D* | peeling |
| Ex. 1 | 280 | 275 | 100 | 279 | 6 | 6 | 22 | 6 | None |
| Ex. 2 | 248 | 252 | 98 | 250 | 8 | 7 | 23 | 8 | None |
| Comp. | 324 | 146 | 95 | 138 | 4 | 13 | 22 | 18 | Present |
| Ex. 1 | | | | | | | | | |
| Com. | 276 | 279 | 98 | 215 | 6 | 6 | 22 | 10 | Present |
| Ex. 2 | | | | | | | | | |

*“A” denotes “A direction”, “B” denotes “B direction”, “C” denotes “C direction”, and “D” denote “B direction”.

In the columns “Thermal conductivity” and “Linear expansion coefficient” in Table 1, “A direction”, “B direction”, “C direction” and “D direction” are, as shown in FIG. 14, means the longitudinal direction A, the width direction B, the thickness direction C, and the oblique direction D of the composite material.

As shown in Table 1, in the composite materials of Examples 1 and 2, the thermal conductivities in the A direction, the B direction and the D direction are substantially equal to each other, and the linear expansion coefficients in the A direction, the B direction, and the D direction were also roughly equal to each other. Therefore, it was confirmed that the physical properties (thermal conductivity, linear expansion coefficient) in the planar direction of the composite materials of Examples 1 and 2 are substantially uniform.

On the other hand, in the composite material of Comparative Example 1, the thermal conductivities in the A direction, the B direction, and the D direction were different from each other, and the linear expansion coefficient in the A direction, the B direction, and the D direction were also different. In the composite material of Comparative Example 2, the thermal conductivities in the A direction and the B direction were substantially equal but the thermal conductivity in the D direction was different from the thermal conductivities in the A direction and the B direction. The linear expansion coefficients in the A direction and the B direction were equal but the linear expansion coefficient in the D direction was different from the linear expansion coefficients in the A direction and the B direction. Therefore, it was confirmed that the physical properties (thermal conductivity, linear expansion coefficient) of the composite materials of Comparative Examples 1 and 2 in the planar direction are poor in uniformity.

<Cold Heat Cycle Test>

The following cold heat cycle tests were conducted on the composite materials of the aforementioned Examples 1 and 2 and Comparative Examples 1 and 2, respectively.

The composite materials of Examples 1 and 2 and Comparative Examples 1 and 2 were each cut into a square shape (size: length 30 mm×width 30 mm), and a silicon carbide plate (SiC plate) of a square shape (size: length 20 mm×width 20 mm×thickness 1.6 mm) was bonded to each surface in a laminated state by soldering. As a result, joined members of Examples 1 and 2 and Comparative Examples 1 and 2 was obtained. Then, a cold heat cycle test at −40° C. to 80° C. was repeated for 3,000 cycles for each joined member.

As a result of this cold heat cycle test, in the joined members of Examples 1 and 2, no peeling occurred at the joining interface. Therefore, it can be confirmed that the composite material of Examples 1 and 2 can be suitably used as a material of a constituent layer of an insulating substrate. On the other hand, in the joined members of Comparative Examples 1 and 2, peeling occurred partially at the bonding interface and further deformed. These results are shown in the column “Presence or absence of Peeling” in Table 1.

The present application claims priority to Japanese Patent Application No. 2015-251416 filed on Dec. 24, 2015, the entire disclosure of which is incorporated herein by reference in its entirety.

It should be understood that the terms and expressions used herein are used for explanation and have no intention to be used to construe in a limited manner, do not eliminate any equivalents of features shown and mentioned herein, and allow various modifications falling within the claimed scope of the present invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. Limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In some examples, various embodiments may include overlapping features. In this disclosure and during the prosecution of this case, the following abbreviated terminology may be employed: “e.g.” which means “for example;” and “NB” which means “note well”.

### INDUSTRIAL APPLICABILITY

The present invention is applicable to a method for producing a metal-carbon fiber composite material and a method for producing an insulating substrate.

### DESCRIPTION OF REFERENCE SYMBOLS

1: carbon fiber
2: binder
3: solvent
5: coating liquid
10: metal foil
10A: strip member of the metal foil
11: carbon fiber layer
12: coated foil
12A: strip member of the coated foil
15: laminate
17: metal-carbon fiber composite material
20: gravure coating device
21: gravure roll
22: cell
28: drying furnace
30: sintering apparatus

1. A method for producing a metal-carbon fiber composite material, the method comprising the steps of:
obtaining a coated foil in which a carbon fiber layer is formed on a surface of a metal foil by applying a coating liquid containing carbon fibers, a binder, and a solvent for the binder in a mixed state to the surface of the metal foil with a gravure coating device provided with a gravure roll in which a number of cells are formed on a circumferential surface thereof;
forming a laminate in a state in which a plurality of coated foils are laminated; and
integrally joining the coated foils by heating the laminate to remove the binder from the laminate and heating the laminate while pressurizing the laminate in a lamination direction of the coated foils,
wherein a shape of the cell of the gravure roll is a cup shape and a diameter of a circle inscribed in a mouth shape of the cell is set to 1.2 times or more an average fiber length of the carbon fibers.

2. The method for producing a metal-carbon fiber composite material as recited in claim 1, wherein
the step of obtaining the coated foil includes a step of removing the solvent from the carbon fiber layer formed on the surface of the metal foil.

3. The method for producing a metal-carbon fiber composite material as recited in claim 1, wherein
the step of obtaining the coated foil includes a step of removing the solvent from the carbon fiber layer formed on the surface of the metal foil without subjecting the surface of the carbon fiber layer to slide leveling processing.

4. The method for producing a metal-carbon fiber composite material as recited in claim 1, wherein
in the step of integrally joining the coated foils, the binder is removed from the laminate in the middle of heating the laminate so that a temperature of the laminate rises to a temperature at which the coated foils are integrally joined.

5. The method for producing a metal-carbon fiber composite material as recited in claim 1, wherein
the shape of the cell is at least one shape selected from the group consisting of a lattice shape, a pyramid shape, a hexagonal shape, and a circular shape.

6. The method for producing a metal-carbon fiber composite material as recited in claim 1, wherein
the metal foil is at least one of an aluminum foil and a copper foil.

7. A method for producing an insulating substrate having a plurality of insulating substrate constituent layers to be integrated in a laminated state, wherein
at least one constituent layer of the plurality of constituent layers is made of a metal-carbon fiber composite material, and
the composite material is produced by a method for producing of the metal-carbon fiber composite material as recited in claim 1.
